(19) United States
(12) Patent Application Publication
(10) Pub. No.: US 2011/0195383 A1
(43) Pub. Date: Aug. 11, 2011

(54) Diet Management System

(76) Inventor: Melanie Weiss, Oak Park, IL (US)

(21) Appl. No.: 13/021,254

(22) Filed: Feb. 4, 2011

Related U.S. Application Data
(60) Provisional application No. 61/301,995, filed on Feb. 5, 2010.

(51) Int. Cl. G09B 19/00

(52) U.S. Cl. 434/127

(57) ABSTRACT

A diet management system having a calorie consumption tracking mechanism, a calorie expenditure tracking mechanism, and a portable device, such as a wallet, comprising an area for bills and an area for coins. The area for bills and the area for coins are each divided into separate regions, such as by a divider. The calorie consumption tracking mechanism may utilize bills to track calorie intake, and the calorie expenditure tracking mechanism may utilize coins to track calorie expenditure. The system may include a water intake tracking mechanism to track the amount of water consumed. A user keeps track of the amount of calories consumed, and/or the amount of exercise activity the user engages in, by moving calorie consumption tracking bills and/or calorie expenditure tracking coins from a first region to a counterpart second section at or about the time calories are consumed and/or expended through exercise.

### RELATED APPLICATION

This application claims the benefit of U.S. Provisional Application No. 61/301,995 filed Feb. 5, 2010, which is herein incorporated by reference.

### FIELD OF THE INVENTION

This invention relates to diet management systems, in particular to diet planning and control systems.

### BACKGROUND OF THE INVENTION

An integral aspect of successful weight loss is keeping track of food consumption and energy expenditure. One common method of keeping track of dietary consumption is through the use of a food journal. A food journal typically consists of a book, a pad, or loose leaf pages that allow people to keep a detailed account of their dietary habits, including the type of food consumed, when the food was consumed, and the user's mood, such as hunger, boredom, or anger, at the time the food was consumed. Food journals are also used to keep track of caloric intake from beverages, to track water intake, and to record energy expended through activity or exercise. Each night, the user tallies the entries in the food journal to determine the day's source of caloric intake and expenditure. Such tracking of caloric intake and energy expenditure by counting calories is highly recommended in order for a person to learn how to make positive dietary changes.

However, tracking methods such as food journals have deficiencies which make the food journal hard for the user to maintain. Maintaining a food journal is often laborious, requiring the user to make entries consistently for days, and often weeks at a time to be effective. Many food journals are cumbersome to take around, thus preventing the user from making an entry at the time food consumption takes place. The lack of portability often requires the user to remember what the user consumed throughout the day, and recall such information for recording at a later time. Thus, some entries may not be recorded correctly, or even recorded at all.

Some people choose to keep track of their caloric intake electronically, such as by using a computer or with a handheld device such as a calorie counting application on the iPhone. Others commit to diet plans such as a JENNY CRAIG, WEIGHT WATCHERS, NUTRISYSTEM, or other diet plan that may be available in books or online. Meticulous tracking of caloric intake, and activities and exercise are essential components of keeping an effective food journal, whether the tracking is done online, on paper, with a computer, or with an iPhone application. The effectiveness of a food journal decreases if a snack or a meal is not recorded properly.

One of the primary goals of maintaining a food journal is to control unconscious eating, provide a tangible record of one's eating patterns, and take the guesswork out of computing the number of calories eaten and expended through exercise in a day. Food journals also help the user manage their calorie allotment over the day, allowing the user to plan food consumption.

The present inventor has recognized the need for a diet management system that is portable and easy to use.

The present inventor has recognized the need for a diet management system which increases user compliance.

The present inventor has recognized the need for a diet management system which can be used to simultaneously track various aspects of a user's diet.

### SUMMARY OF THE INVENTION

In one embodiment, the diet management system comprises a portable organization device, such as a wallet, comprising an area for bills and an area for coins. The coin area may be a small pocket on an outer or inner surface of the wallet. The area for bills and the area for coins are each divided into separate regions, such as by a fabric divider. Each divided section of the area for bills and the area for coins are further delineated such as by color, so that the divided sections of the coin area and the divided sections of the area for bills can be differentiated from its counterpart section. Other portable devices such as a folder, purse, billfold and the like may be used.

The diet management system further comprises a calorie consumption tracking mechanism, and a calorie expenditure tracking mechanism for tracking aspects of dietary regimen. In one embodiment, the calorie consumption tracking mechanism can utilize bills to track calorie intake, and the calorie expenditure tracking mechanism can utilize coins to track calorie expenditure. The bills are printed with numerical values corresponding to calories. In other embodiments, the bills are printed with points for use with dietary regimens utilizing a point system such as WEIGHT WATCHERS, with meal combinations of pre-determined calorie values, or with a similar calorie counting method for use with a food plan from a documented diet plan or other source. Coins representing exercise activity, which display the calorie expenditure associated with performing each activity, are used to keep track of the exercise in which the user engages. Coins representing other aspects of a dietary regimen, such as water intake, can also be used to keep track of the amount of water consumed throughout a day.

The user keeps track of the amount of calories consumed, and/or the amount of exercise activity the user engages in, by moving calorie consumption tracking bills and/or calorie expenditure tracking coins from one section to its counterpart section as calories are consumed and/or expended through exercise. The user has the option to update the wallet with differing amounts and or types of bills or coins on a daily basis, allowing flexibility to choose from different food plans and dietary needs. Tracking devices are not limited to a bill for tracking calorie consumption or a coin for tracking calorie expenditure. Tracking devices can be any suitable size, shape, and material for use with the desired portable organization device.

In another embodiment, both tracking devices can be rectangular. Calorie consumption and/or calorie expenditure tracking can be monitored through the use of tracking mechanisms printed onto rectangular cards. Rectangular cards can be differently shaped or sized for easier identification of the type of consumption or activity the tracking mechanism card represents. The cards can also be color coded to further categorize aspects of a person's daily calorie intake and expenditure, as well as other types of dietary intake. For example, tracking mechanisms can be used to track a person's intake of liquids, such as the amount of water or soda a person drinks daily. Tracking mechanisms can also be used to track activity type, and/or duration of said activity.

The diet management system can be custom configured to suit the tracking needs of an individual. For users that prefer a more detailed tracking of their dietary consumption or calorie expenditure, specific tracking mechanisms that track, for example, daily water intake, intake by food groups, types of beverages ingested, or exercise type, can be used. For each aspect of a person's dietary plan that is tracked, the tracking mechanism may be the same shape or sized card, yet printed to represent the dietary aspect being tracked. Alternatively, the tracking mechanism tracking each dietary aspect may be a different color or shape than other tracking mechanisms for easier visual identification of the tracking mechanism.

In another embodiment, the diet management system can also be used for other health related food consumption, and not just by users desiring to lose weight The diet management system of using tracking mechanisms to track consumption can also be used by those with high blood pressure to monitor salt in take, for example, or by diabetics to monitor carbohydrate intake. The use of tracking mechanisms to track various aspects of a user's diet can also be used by children to teach children about food groups and assist in establishing early healthy eating habits.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates a wallet for use with an exemplary embodiment of the diet management system of the present invention.

FIG. 2A schematically illustrates a calorie consumption tracking mechanism in the form of a bill for use with an exemplary embodiment of the diet management system.

FIG. 2B schematically illustrates a calorie consumption tracking mechanism in the form of a bill for use with another exemplary embodiment of the diet management system.

FIG. 2C schematically illustrates a calorie consumption tracking mechanism in the form of a bill for use with yet another exemplary embodiment of the diet management system.

FIG. 3 schematically illustrates a calorie expenditure tracking mechanism in the form of a coin for use with an exemplary embodiment of the diet management system.

FIG. 4 illustrates tabs and slots for use with another embodiment of the diet management system.

FIG. 5 illustrates another embodiment of a wallet for use with the diet management system.

FIG. 6 illustrates another embodiment of an organizer for use with the diet management system.

FIG. 7 illustrates yet another embodiment of an organizer for use with the diet management system.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

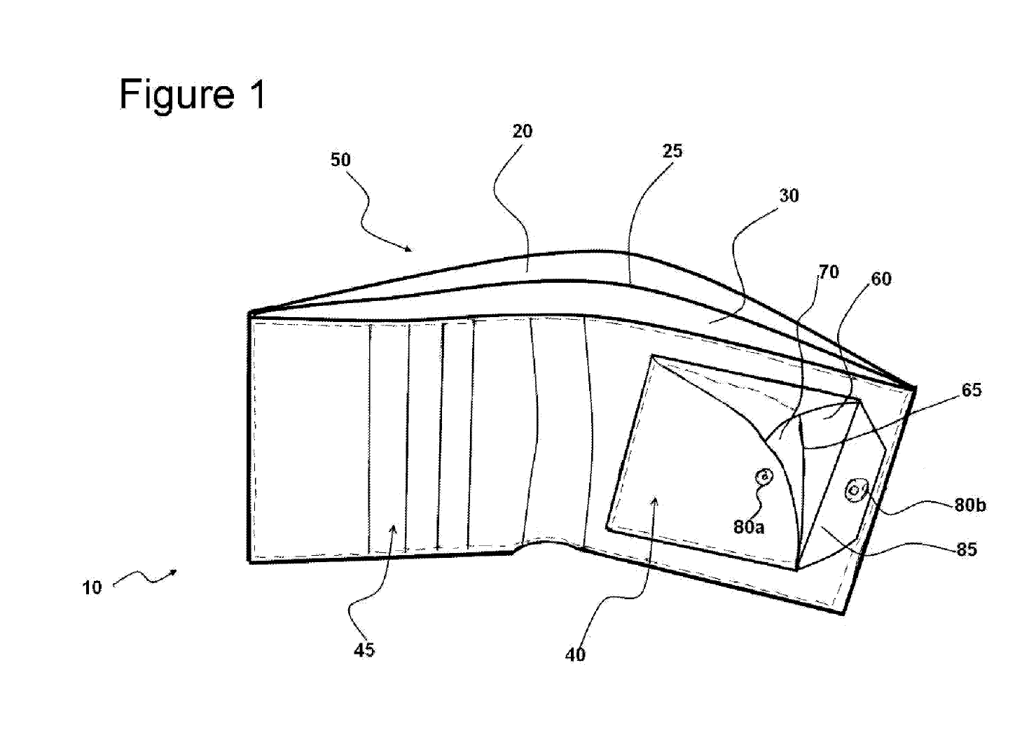

FIG. 1 illustrates a wallet 10 for use with an exemplary embodiment of the diet management system. The wallet 10 comprises an area for bills 50, and an area for coins, such as a pocket 40. The area for bills 50 is divided into two separate regions 20, by a bill region divider 25. The separate regions include a first region 20 and a counterpart second region 30. The area for coins 40 is divided into two separate regions, including a first region 60, and a counterpart second region 70 by a coin region divider 65. Region dividers 25, 65 may be fabric dividers or other suitable material. The area for bills 50 and the area for coins 40 can also be divided into more than two separate regions.

The region for coins 40 may be closed by a fastening mechanism, such as a snap button with a first engaging mechanism 80a, and a second engaging mechanism 80b, to prevent the contents from falling out. The first regions 20, 60 may be delineated from their counterpart second regions 30, 70 respectively, by color coding the first region a different color from the corresponding counterpart region. Counterpart regions may also be delineated by labeling the region with words, such as for example, “BEGIN” and “END”, “STOP” and “GO”, and the like. The wallet 10 may further comprise a card carrying region 45 to contain cards with nutritional information. In another embodiment, instead of having one area for bills and one are for coins each being separated into two regions, the wallet may comprise a first and second area for bills and a first and second area for coins, each optionally color coded.

The diet management system further comprises a calorie consumption tracking mechanism and a calorie expenditure tracking mechanism. The calorie consumption tracking mechanism may be designed in shape and feel similar to a paper currency bill, and printed with dietary information. The bills are of a suitable size to fit into the wallet, and are the similar in size to paper currency to provide user familiarity, however bills of other sizes can also be used. The bills can be made of paper, paper composite, thin plastic, or other suitable material that is flexible, durable and capable of withstanding daily handling.

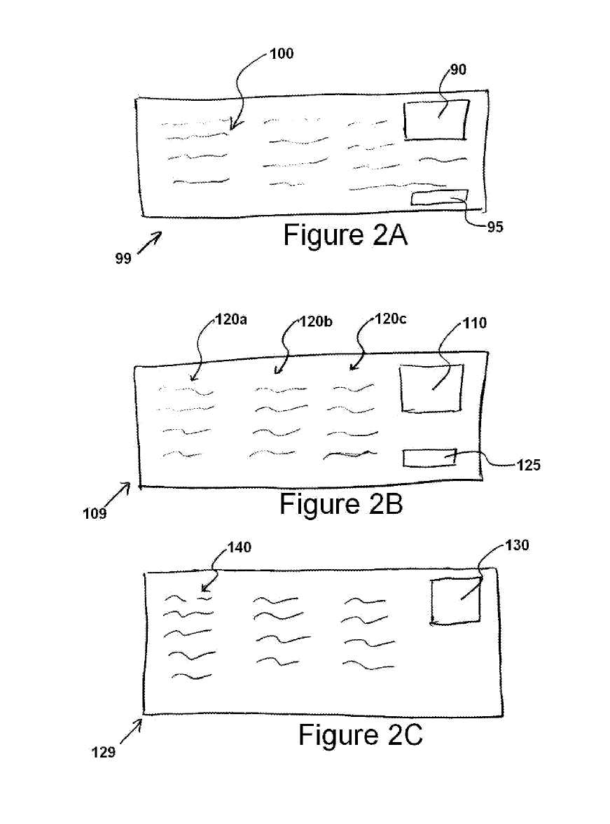

FIG. 2A is a schematic diagram of a calorie consumption tracking mechanism. The calorie consumption tracking mechanism is a calorie consumption tracking bill 99 comprising a calorie value indicator 90, which displays a caloric value. The calorie consumption tracking bill 99 further comprises a list 100 of food types and portions which, when consumed, will be the equivalent of consuming the amount of calories displayed on the calorie value indicator 90. The calorie consumption tracking bill 99 can further comprise a meal type indicator 95, to indicate whether the food type is a “SNACK” or “BEVERAGE”, a meal type, or other categorization. The calorie consumption tracking bill 99 may also be color coded.

FIG. 2B is a schematic diagram of an alternate embodiment of a calorie consumption tracking bill 109. The calorie consumption tracking bill 109 comprises a calorie value indicator 110 which displays a caloric value corresponding to the various meal combinations 120a, 120b, 120c displayed on the calorie consumption tracking bill 109. The calorie consumption tracking bill 109 can further comprise a meal type indicator 125 to indicate which meal—breakfast, lunch, dinner, snack, or other equivalent, that the meal combination displayed is suited for. Any other methods for organizing or categorizing caloric information of particular food items can also be used.

In other embodiments, the diet management system is used with a food group consumption tracking mechanism. FIG. 2C is a schematic diagram of a food group consumption tracking mechanism such as a food group consumption tracking bill 129. The food group consumption tracking bill 129 comprises a food group indicator 130, which displays the food group, and serving size, of the food group being tracked. For example, the food group indicator 130 could display “Vegetables, 1 serving.” Various vegetables, and the corresponding amount of each type of vegetable to be consumed in order to equal the amount displayed in the food group indicator 130 are listed 140 on the food group consumption tracking bill 129.

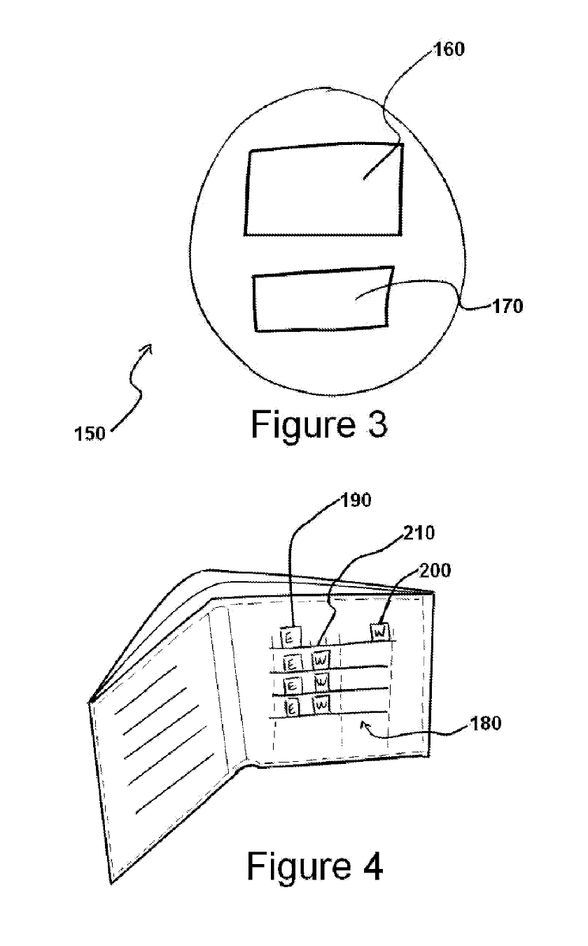

The calorie expenditure tracking mechanism can comprise coins, tokens, tabs, cards, bills, and the like, or any other type of tracking mechanism suitable for use with a portable device such as a wallet. The calorie expenditure tracking mechanism, such as a calorie expenditure tracking coin 150 schematically illustrated in FIG. 3, can comprise an exercise indicator 160 which communicates to the user the type of exercise activity being represented by the coin, such as a picture of a bicycle or the word “biking.” The calorie expenditure tracking coin 150 further comprises a calorie expenditure display 170, which displays the calorie expended, for example, per increment time spent performing the exercise activity. In an alternative embodiment, the user can customize the calorie expenditure tracking mechanism to correspond to their most frequent activities. For example, the user may affix appropriate stickers selected from a series of stickers indicating different types of activity to the calorie expenditure tracking mechanism, or the user may choose to simply write their preferred activity and the corresponding calorie expenditure in the exercise indicator 160 and the calorie expenditure display 170. Information such as the exercise indicator and the expenditure display can also be displayed on tokens, tabs, cards, bills and the like. Other exercise or caloric expenditure information in addition to exercise type and expenditure can also be displayed. Calorie expenditure information can also be used to keep track of the amount of exercise, for example by exercise duration increments.

In an alternative embodiment, the diet management system comprises a water intake tracking mechanism. The water tracking mechanism can use a tracking mechanism comprising of coins, tokens, tabs, bills, and the like, or any other type of tracking mechanism, similar to the calorie consumption or calorie expenditure tracking mechanisms.

The diet management system provides daily guidance to users adhering to a specific eating program or plan. For example, a user may have a daily allocation for consumption, such as 25 points on a diet program, such as a WEIGHT WATCHERS diet program, corresponding to 1,600 calories. A user with a daily point allocation of, for example, 25 points, would identify calorie consumption tracking bills representing one point, two points, and so forth until a total of 25 points are accumulated. The bills are placed in a first separate region 20, which may be delineated from its counterpart region 30 by a color, such as green to represent “GO.” Each calorie consumption tracking bill displays the food equivalent of the point value indicated on the calorie consumption tracking bills. As the user consumes food throughout the day, the user takes the calorie consumption tracking bills corresponding to the point equivalent to the food consumed and moves the bills to its counterpart region 30, which may be colored red to represent “STOP”. By moving the calorie consumption tracking bills from one separated region to another as food is consumed, the user is able to effectively monitor his or her food intake, and to plan meals accordingly with the remaining portion of daily allocated points.

A user with a daily calorie allocation instead of a point allocation would use the diet management system, and the calorie consumption tracking mechanism in a similar fashion. The user with a 1600 daily calorie allocation, for example, may select calorie consumption tracking bills corresponding to three separate 400 calorie meals, and two 200 calorie snacks for deposition into a first separate region 20. As calories are consumed, the calorie consumption tracking bill is moved from the first separate region 20 to its counterpart region 30.

The diet management system allows the user flexibility in meal planning by providing the user the opportunity to plan their daily meals. The diet management system also allows the user flexibility in choosing how to allocate their remaining points or calories by having in front of them meal options when they make their food choices for that part of the day. If by dinner time, for instance, 400 calories are left in the “GO” side, the user can look at the meal combinations or food suggestions on the remaining calorie tracking bills to determine what they can eat for dinner to stay within their allotted caloric limit.

The calorie tracking mechanism can be in point value or caloric denominations suitable for use with particular diet plans, or the particular user. For example, a user with a preference of smaller snacks throughout the day may choose a greater number of smaller denominations than the user who snacks less and prefers substantive meals and thus chooses greater caloric denomination combinations. Caloric denominations can be, for example, 40, 50, 80, 100, 150, 200, 250, 300, or 350 calories, which can represent meal combination and/or individual items. Caloric denominations may also be user defined. By having various denominations, the user may customize their daily consumption to meet exact dietary requirements. The caloric denominations can also be in denominations similar to monetary denominations for user familiarity.

The diet management system can also be used to track alignment with a healthy eating recommendation, such as the five food groups within the USDA food pyramid, with the food group consumption tracking bill 129 being used to track the consumption of servings of fruit, vegetable, protein, fat, grains, dairy, etc. A user would place food group consumption tracking bills representing food groups for consumption in one of the separate regions 20, 30. As the particular food group is consumed, the user moves the food group consumption tracking bill from the first separate region, to its counterpart region. The same concept of moving the water intake tracking mechanism, and/or the calorie expenditure tracking mechanism, from a first separate region to the counterpart region as each unit of water, or each type of exercise is completed, is used to keep track of the water consumed, and/or exercise activity performed throughout the day.

The user uses the calorie expenditure tracking mechanism and the water intake tracking mechanism in the similar fashion of moving one tracking mechanism from one region to another at or about the time the activity being tracked is performed. The calorie expenditure tracking mechanism, such as coins, in the area for coins will record a person's activity for the day. One side of the coin will represent the activities that expend a certain amount of calories, with the calorie amount printed on the same or flip side of the coin. The separate regions 60, 70 of the pocket 40 may be color coded, such as using the colors green and red, respectively, similar to the regions for bills. A user places coins in the green side that represent the activity they plan to participate in for the day. Once they have achieved the exercise/activity goal and expended the calories, they can move a coin to the red side. Accordingly, the user is able to record the activity performed at or about the time the activity is performed. At the end of the day, the user is able to determine whether a daily recommended exercise amount has been completed, and/or track whether a daily net caloric intake goal has been met. For example, a user can carry with them several calorie expenditure mechanisms corresponding to a particular activity associated with a calorie expenditure if the activity is carried out for a certain amount of time. A user can have the option of keeping track of exercise activity as it is accomplished piecemeal throughout the day, and move the caloric expenditure mechanism corresponding to the appropriate increment of time, into a second region to keep track that the activity has been completed. A user can likewise track daily consumption of recommended 8-10 glasses of water each day in a similar fashion, by moving water intake tracking mechanisms, such as coins, from one separate region to its counterpart region.

In another embodiment, the diet management system can also be used to track dietary consumption for specific health related issues. For example, those with high blood pressure desiring to monitor salt intake can track salt intake by using a tracking mechanism representing salt intake. The user moves the tracking mechanism from a pre-consumption region to a post-consumption region to track the amount of salt consumed. Likewise a user who is diabetic can use the diet management system to track the amount of carbohydrates consumed. The use of tracking mechanisms to track aspects of a user's diet for purposes other than weight loss can also be used by children to teach children about food groups, portion control, and assist in establishing early healthy eating habits. The tracking mechanism can be used to keep track of food items consumed by a person over a set time period, rather than used for maintaining consumption within a pre-determined allocation.

The diet management system provides a portable device which allows the user to build their diet for the day and which they can carry easily with them throughout the day to remind the user of their daily food requirements and allowances. The diet management system is a simple method of keeping track of food consumed during the day, encouraging the user to adhere to his or her daily allocation of calories while simultaneously keeping track of calories expended and water consumed. The diet management system provides a quick and easy method for tracking calories as there is no writing, no adding up food calories, no searching for a pen (or computer) every time the user eats, and no hassle in keeping an easy and accurate record of a day's food and beverage intake. As demonstrated, the calorie consumption tracking mechanism can be adapted to fit diet books on the market, to fit diet plans currently being used, or just simply to record a person's daily caloric and water intake by tracking food and beverage choices, with the versatility of counting food intake in a variety of different ways.

In another embodiment, the calorie expenditure tracking mechanism, and/or the water intake tracking mechanism can also be in the form of bills. The calorie expenditure tracking mechanism may be bills with a negative value displayed, such that the user can take out the bills on the counterpart region of the wallet at the end of the day, and tally up the net calorie consumed.

In yet another embodiment, the calorie expenditure and/or water tracking mechanism can be rectangular tabs representing exercise 190 and/or water 200, which can be moved from one slot 210 to another in a slotted region 180 as illustrated in FIG. 4.

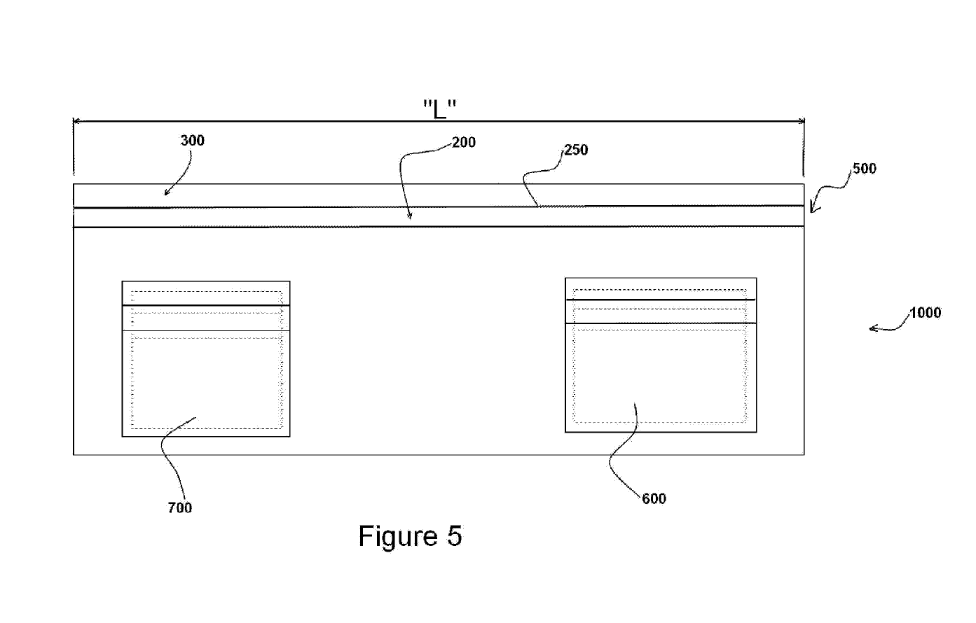

In the embodiment illustrated in FIG. 5, the portable organization device is a wallet 1000 with an area for bills 500, and an area for cards 600, 700 such as plurality of card slots. The area for bills is delineated into two separate regions 200, 300, but can contain more than two regions. The delineation of the region can be by the use of a divider panel 250 extending along the entire length “L” of the wallet 1000. For easier access to the regions 200, 300, the wallet can have the openings to the regions 200, 300 staggered or shingled, as illustrated in FIG. 5. Likewise the region for cards can be staggered or shingled to allow for easier access to the contents. The region for cards can comprise vertical slots 45 as illustrated in FIG. 1. Card or tabs which fit within the card slots can be used to track aspects of a user's diet, such as nutritional information, amount of exercise, water consumption, food group consumption, and any other diet or nutritional information. The wallet can have more than two regions for cards to enable the user to track more aspects of their diet.

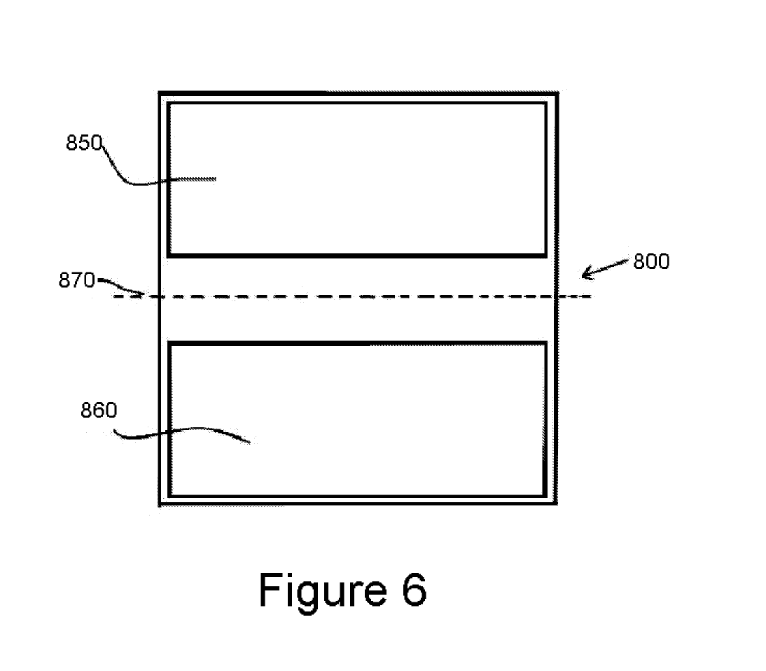

FIG. 6 illustrates yet another embodiment of a portable organization device suitable for use with the diet management system. The organization device 800 of FIG. 6 has two regions 850, 860 which are disposed in a top down arrangement. When folded along the central horizontal axis 870, the two regions face opposite each other in a folded configuration. The two regions can be pockets, as illustrated, and/or can comprise slits or slots for holding bills, cards, and the like. One of the regions 850 can be a first region for pre-consumption storage, and/or pre-calorie expenditure storage of the consumption and/or calorie expenditure tracking mechanisms, respectively. As food items, water, or other ingestible are consumed, the appropriate tracking mechanism is moved to the second region 860 which is a post-consumption and/or post-calorie expenditure storage region. In this embodiment, the consumption tracking mechanism and the calorie expenditure tracking mechanism can be placed together in the same region.

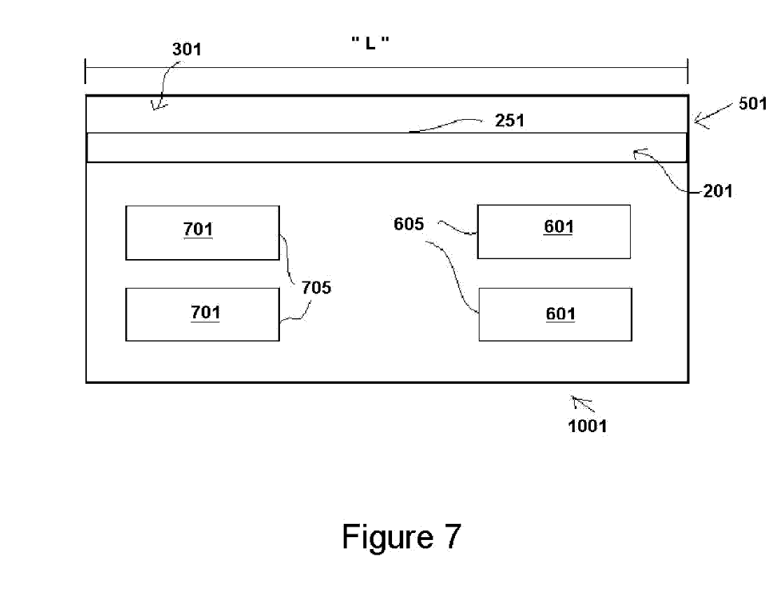

FIG. 7 illustrate an alternate embodiment of a portable organization device suitable for use with the diet management system. In the embodiment illustrated in FIG. 7, the portable organization device is a wallet 1001 with an area for bills 501, and an area for cards or tabs, such as plurality of card slots 601, 701, organized on either side of the wallet. The area for bills is delineated into two separate regions 201, 301, but can contain more than two regions. The delineation of the region can be by the use of a divider panel 251 extending along the entire length “L” of the wallet 1001. For easier access to the regions 201, 301, the wallet can have the openings to the regions 201, 301 staggered or shingled, as illustrated in FIG. 7.

The card slots 601, 701 are organized such that two card slots are on either side of the wallet. The number of card slots on either side can be more or less than two card slots. More card slots can be used if additional types of tracking mechanisms are used. The card slots 601, 701 as illustrated in FIG. 7 have openings 605, 705 on the side of the card slot. Openings can also be on other sides of the card slots 601, 701. Card or tabs which fit within the card slots can be used to track aspects of a user's diet, such as nutritional information, amount of exercise, water consumption, food group consumption, and any other diet or nutritional information when the card or tab is moved from a pre-consumption or pre-exercise region, to a post-consumption or post exercise region.

The portable organization device can be a wallet used to simultaneously carry monetary currency and the tracking mechanisms of the diet management system. For example, the area for bills 501 in FIG. 7 can be used for holding tracking mechanisms shaped like a bill, as well as currency bills. The tracking mechanisms pre-consumption can be placed in the same region, for example 301, as paper currency bills. Post consumption, the tracking mechanism is moved to region 201. Alternatively, the area for bills can be delineated into more than two regions, for example into three regions, wherein paper currency bills, pre-consumption tracking mechanisms, and post-tracking mechanisms have their own delineated regions. The portable organization device for use with the diet management system can include features common to a wallet, such as having slots for carrying credit cards and a driver's license. A user would then not need to carry a separate portable organization device in addition to a wallet for currency that the person may otherwise be carrying.

The portable organization device can be made from a suitable durable material, such as vinyl, canvas, leather, cotton, and other synthetic or natural materials, or a combination thereof.

From the foregoing, it will be observed that numerous variations and modifications may be effected without departing from the spirit and scope of the invention. It is to be understood that no limitation with respect to the specific apparatus illustrated herein is intended or should be inferred.

1. A diet management system comprising:
at least one consumption tracking mechanism,
an organizing device for use with the consumption tracking mechanism, said organizing device comprising a first region for receiving a consumption tracking mechanism.

2. The diet management system of claim 1 further comprising:
a second region for receiving at least one consumption tracking mechanism.

3. The diet management system of claim 2 wherein the consumption tracking mechanism is made from a flexible material.

4. The diet management system of claim 1 wherein the consumption tracking mechanism is a caloric consumption tracking mechanism displaying caloric information for at least one food item.

5. The diet management system of claim 1 wherein the consumption tracking mechanism is a caloric consumption tracking mechanism displaying caloric information for a combination of food items.

6. The diet management system of claim 1 wherein the consumption tracking mechanism is a food group consumption tracking mechanism comprising information on a food group.

7. The diet management system of claim 2 wherein the first region is pre-consumption storage and the second region is a post-consumption storage, and wherein the consumption tracking mechanisms are moveable between the pre-consumption storage and the post-consumption storage to track the calories consumed by a user.

8. The diet management system of claim 2 wherein the organizing device is a wallet, said wallet having the first and second regions adjacent to each other.

9. The diet management system of claim 1 further comprising at least one calorie expenditure tracking mechanism.

10. The diet management system of claim 9 further comprising a first section for receiving one or more of the calorie expenditure tracking mechanisms, and a second section for receiving one or more of the calorie expenditure tracking mechanisms.

11. The diet management system of claim 10 wherein the first section is pre-calorie expenditure storage and the second section is a post-calorie expenditure storage, and wherein the calorie expenditure tracking mechanisms are moveable between the pre-calorie expenditure storage and the post-calorie expenditure storage to track the calories expended by a user.

12. The diet management system of claim 9 wherein the calorie expenditure tracking mechanism is a card with caloric expenditure information.

13. A method of tracking calorie consumption of a user with an organizer comprising the steps of:
selecting one or more caloric tracking mechanisms corresponding to a desired caloric allocation;
placing the one or more calorie tracking mechanism within a first region in an organizer;
selecting one or more calorie tracking mechanisms corresponding to the amount of calories consumed by the user from the first region;
moving the selected one or more calorie tracking mechanisms corresponding to the amount of calories consumed by the user from the first region of an organizer to a second region of the organizer.

14. The method of tracking calorie consumption of claim 13 further comprising:
selecting one or more calorie expenditure mechanisms;
placing the one or more calorie expenditure mechanisms within a first region for receiving calorie expenditure mechanisms;
selecting one or more calorie expenditure mechanism corresponding to the amount of calories expended by the user from the first region;
moving the one or more selected calorie expenditure mechanisms corresponding to the amount of calories expended by the user from a first expenditure region to a second expenditure region.

15. The method of claim 14 further comprising the step of calculating a user's net calorie consumption by determining the difference between the calorie consumed and the calories expended as represented by the placement of calorie consumption mechanisms and the calorie expenditure mechanisms in the organizer.

16. A method of tracking dietary information comprising the step of:
moving a tracking mechanism representing one aspect of a diet system from one region in a portable organizer to a second region in the portable organizer to keep track of the one aspect of a diet system.

17. The method of claim 16 wherein the aspect of a diet system is the amount of calories consumed.

18. The method of claim 14 wherein the aspect of a diet system is the amount of calories expended.

19. The method of claim 14 wherein the aspect of a diet system is consumption by food group.

20. The method of claim 14 wherein the aspect of a diet system is the amount of water consumed.
